(19) United States
(12) Patent Application Publication
(10) Pub. No.: US 2012/0317881 A1
(43) Pub. Date: Dec. 20, 2012

(54) Composting garden pot

(76) Inventors: Aparna Thirumalai Anandampillai, Chennai (IN); Anand Vishnu Thirumalai Anadampillai, Chennai (IN); Vijayan Thirumalai Anadampillai, Chennai (IN)

(21) Appl. No.: 13/507,415

(22) Filed: Jun. 25, 2012

(30) Foreign Application Priority Data
Dec. 30, 2009 (IN) 3242/CHE/2009

(51) Int. Cl. A01G 9/02

(52) U.S. Cl. 47/66.5

(57) ABSTRACT

This new composting opaque garden pot (1) of chosen shape, size, and material has at least two removable partitions (2) with multiple root holes (3) covered by a sliding plate (4) forming plant and composting chambers. The plant chamber has a side excess water drain hole (6); an inside plant stem support tube insert (7) and filled with garden soil (11). The compost chamber is primed with earth worm and decomposing germs. Organic waste is (12) filled, covered with soil and composted in few weeks. The plant roots grow into partition holes (3) and suck up this nutrition for faster growth and more yields. Tree pots are bottom open cylinders with a detachable upper inlet (8) with its lid (9), a pull off handle and an inside cylindrical plastic film tube (14). Organic waste forms vegetables and fruit plants in few weeks with free nutrition, lower pollution, carbon trapping & lower global warming with more food security.

### TECHNICAL FIELD

This invention in general relates to garden pots that composts organic waste and in situ planting using the compost as fertliser for plants.

### STATE OF ART

Existing garden pots grow plants and do not compost any organic waste. If an organic waste is left on pot's surface, it is attacked by birds, insects and soon emits foul smell. Separate composting bins with no planting are sold. Large organic waste from vegetables, meat, fish etc of homes, hotels are collected and sent to city dumping yard, where the waste is land filled with air, water and land pollution. Pesticide free organic healthy food from composting pots at home saves on waste disposal cost and food buying costs. The growing plants trap dust, CO2, give Oxygen, and purify city air.

Composting by landfills is costly & land, air, water polluting. Vermicompost needs special many big tanks and good care with more time. Pit composting, you need to dig the soil, covering it up and is messy. There is no simple composting solution. Ideal composting garden pots should be: 1. Compost daily all organic waste. 2 should be clean, smell free. 3 allow plants to use up the compost for more growth 4. Easy to plant, run and use. 5. Safe and reliable. There are no simple pots as of now!

The following description gives critical examination of the pots for planting known in the art. It also discusses the shortcomings of the conventional methods. Further in order to overcome the problem associated with composting, the invention offers the solution to overcome the impediments in the construction and the process of using the same.

Defects in all existing garden pots are as follows:
1. There is no clean, easy, simple fast composting.
2. The pots need more time & care.
3. There is health risk if organic waste is added to pots.

Accordingly the object of the invention is to identify the solutions for problem associated with the conventional pots. An extensive search has been carried out using the Internet and related patent specifications were studied for pots that can compost and allow plant growth in same pot except WO 2009081419 by T. A. Vijayan et al (ours). This invention needed more refinement and improvements for faster composting, ease of production, lowered cost, easy use. The waste was put in a chamber through a snout and covered with lid with vent holes. This air entry made the decomposition slower of over 4-5 weeks in tropics. The pot has many parts with mass production, packaging, transport difficulties. The new invention uses anaerobic sub soil bacteria for more rapid composting in 2-4 weeks with no air vents in tropics. Since the present invention is different, using the same pot for composting and plant growth, fewer parts with ease of use and production, the inventors are unable to site any patent specification out of the available databases. Only separate composting chambers and pots are seen globally. The invention is directed to a novel type of easy composting pots for use even by kids and women too, at home. There are no snouts, no lids with faster sub soil anaerobic decomposing.

Accordingly it is the primary object of the invention to invent a novel composting pot, which is unique in design and construction, working and use. Further objects of the invention will be clear from the ensuing description.

### SUMMARY OF THE INVENTION

The device comprises of a pot with three chambers—with a central plant and outer two composting chambers formed by two partitions. The partitions have root holes closed by a slide off plate for roots to suck up the nutrients from the compost part to grow faster and yield more fruits and vegetables. The non-composting central plant chamber is filled with garden soil; then seeded for plant growth. The daily organic waste is mashed and fed into composting chamber and layered with soil. The home waste is decomposed by soil germs and yields the nutrients to the root of plant for faster, better growth. The organic waste becomes the needed fertilizer for vegetables and fruit plants. The pots can be placed indoors or on windows, roof tops, sit outs with any open sunny place. The pots will be made in various shapes and sizes depending on the plant root system and its yield. A series of 20 pots can recycle all home waste eternally with different types of plants (each two for cross pollination.) as free safe home nutrition with no city garbage collection, transport, disposal costs running into millions. For trees, pots are modified with only the composting chamber formed out of plastic film tubes with a reusable shell.

### STATEMENT OF DRAWINGS

These and other objects and features of the invention will become more apparent upon perusal of following description taken in conjunction with accompanying drawings wherein:

FIG. 1 shows in elevation the details of a rectangular composting pot.

FIG. 2 shows the various components of the pot.

FIG. 3 A, B, C shows the view of the pot—plant growth and composting.

FIG. 4. shows a modified cylindrical pot.

FIG. 5. shows a composting pot modification for trees.

FIG. 6 shows a tree surrounded by pots in various composting stages.

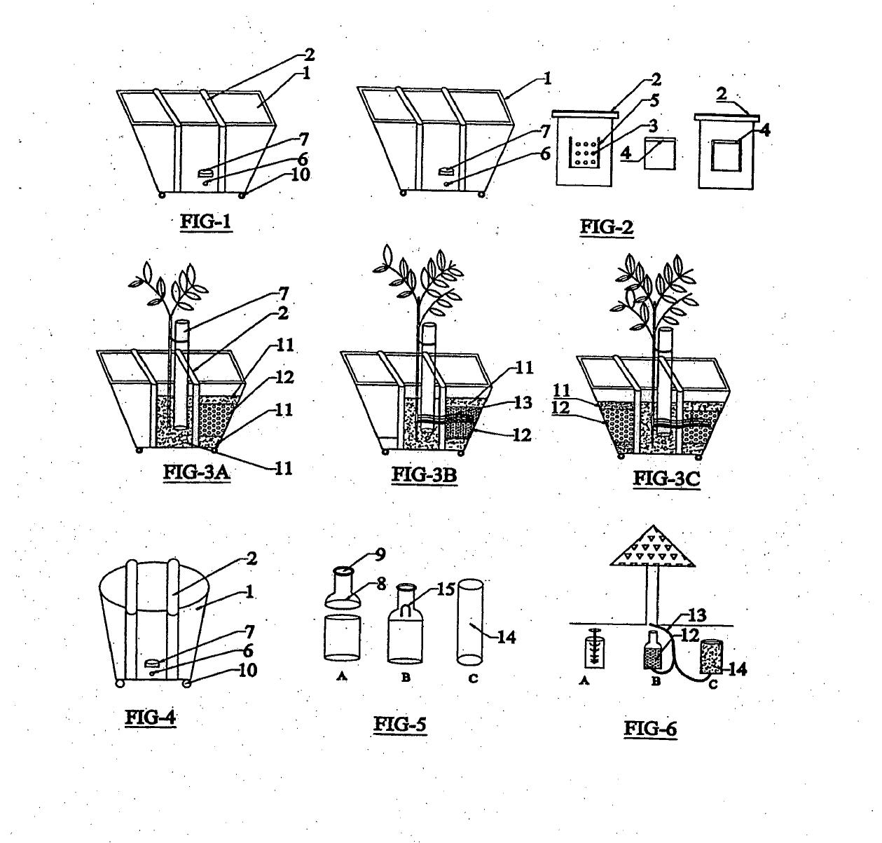

### DESCRIPTION OF PREFERRED EMBODIMENTS

The following specification describes salient features of invention, the method of construction, the method of use and the advantages of the novel invention.

The novel device has a pot made of plastic, clays or metal with two removable partitions and three chambers. The partitions have holes for roots. The central plant part of pot is filled with garden soil and planted. The outer chambers compost waste. The novel pot is placed on any open sunlit surfaces or roof for plant growth.

The novel pot according to invention is better because the all organic waste is composted at home. The plants in few weeks give vegetables or fruits too at zero cost and in plenty. The city avoids organic garbage collection cost. Oxygen is increased; carbon dioxide is trapped as sugar by photosynthesis. Home and city air is now healthy. Special feature of the invention is that it is easy to set up and use even by illiterates or kids too.

The novel device if mass used has higher efficiency of decreasing global warming by converting CO2 to sugars by photosynthesis. The existing garden pots have not been improved for long. The object of the invention is to overcome the inherent defects. To this end the new invention is addressed.

The new pot comprises of an appropriate sized garden pot 1, with removable two partitions 2 sliding in grooves of the pot forming three chambers—a central plant chamber and outer two composting chambers. The partition has many holes 3 for roots. The holes are covered shut by a plate 4 sliding on a slot 5 (FIG. 2) of the partition. The central plant chamber is filled with garden soil and planted. Water drain 6 on one side removes excess water. There is an inside pot plant stem support 7 insert, on which long tubes may be inserted. Bottom wheels 10 move the pots.

FIG. 3 shows the working of pot. In FIG. 3A the central plant chamber is filled with soil 11 and germinated with needed plant. The organic waste 12 FIGS. 3B is fed into one outer compost chamber seeded with composting bacteria and covered by a layer of soil 11. The soil bacteria, earthworms compost the organic wastes. The sliding plate 4 after few days is slid out of the partition 2 and is removed. The plant roots 13 then pass into holes 3 of the partition 2 take up the nutrients of compost and allow faster plant growth. The organic waste is better filled as a mashed waste to decrease the composting time. Smaller pieces are faster decomposed than larger pieces. The soil germs convert all organic residues to active compost. The broken down proteins fats, carbohydrates, Nitrates, phosphates minerals etc are absorbed by roots. A series of pot sequentially compost all days waste. FIG. 3C, the second composting chamber is filled with organic waste 12 and soil 11 covered. The sliding plate is removed after few days to allow the new roots to pass through the partition holes on this side. Growing two plants of same species in two pots helps easy cross pollination and more yield. When the plant dies, the soil is taken out and dried. The compost chamber is emptied into plant chamber and dried soil is added for new seeding. The compost chamber is primed with little of manure, earthworms, and soil germs again for next plant yield. Some plants need stem support in growth. There is a plastic tube insert 7 in plant part for climber's plant's stem support. Plastic pipes fixed in this insert 7 and surrounded by soil is a good support for plant's stem on windy days too. The taller plastic pipes can be joined by cross bars as scaffold for climber plants as snake gourd, beans, etc. A plastic film may be spread on top of soil in the pot to prevent water evaporation in hot days. A series of 20 pots with 40 chambers can recycle all home waste eternally with different types of plants in pairs. All sunny open parts of home—roof, balcony, door steps. Etc for placing the pots—can be used adding to beauty of the house with decreased global warming and more food.

FIG. 4 shows a modification for cylindrical pots with two partitions with central plant chamber and outer composting chamber.

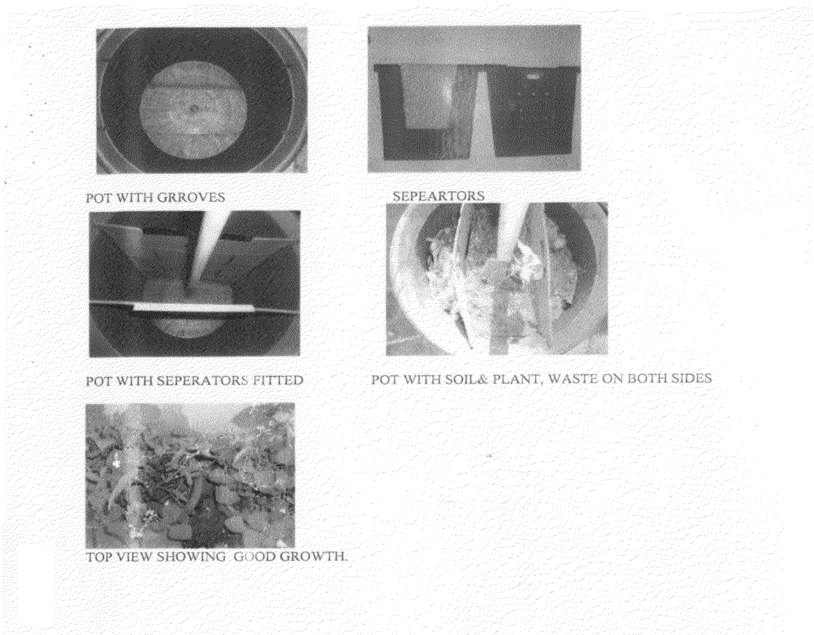

FIG. 5 shows a modification for trees, since trees cannot be grown in pots. A cylindrical body of tree pot is made as two halves with smooth top with waste inlet 8, cover 9, a handle 15 and open bottom for the root entry and nutrient supply from waste. A plastic film tube 14 insert is inserted inside the cylinder for easy pullout and reuse. The tree pots are larger in size taking in many days of organic waste. Depending on free, many pots can be used around a tree. In FIG. 6A, a hole for the size of the tree pot (FIG. 6A) is dug in ground. Tree pot inserted in dug hole, FIG. 6B, the organic waste is fed through the inlet 8 after removing the cover 9 and layered with soil. Roots 13 go to the compost inside the pot. When full, the pot can be pulled out (leaving the inside film tube with compost for a very low plastic use), FIG. 6C and used in another place. The pulling handle 15 fixed to top of the tree pot can be used to pulled off the pot from ground and fitted with another film tube for reuse saving on pot costs and plastic pollution. The diameter of the tree pots may be above 30 cms and height more than 60 cms with 40 liter capacity for many days' waste composting use.

The pots can be modified. They may be made from earth, clay, porcelain, metals, plastics of any safe type UV stabilised, cast or moulded. The pots may be of any shape, size needed with outside ornamentation. The composting chamber may be of any shape—circle, square, etc. The partition hole size, number may be varied for different plants—more for roots with more branches. The pots may be made with a central plant part with removable multiple partitions and multiple compost chambers for sequential organic waste feed to composting chambers. After death of the plant, the plant is composted in pots planted with another plant species, avoiding plant diseases. The pot 1, partition 2 with holes 3 and sliding plate 4 are made in different dies and fitted. For tree pots three dies may be used—an upper with inlet 8, its cover 9, handle 15 and lower pot part with open hole for root nutrition. The film tubes are cut from a larger tube rolls and fitted to inside of the tree pot. Typical volumes of pots for small plants may be 20 liters, more for bigger plants.

It will be apparent to those skilled in the art that modifications to the invention described herein can readily be made without departing from the spirit of the invention. Protection is sought for all the subject matter described herein including any such modifications.

### ADVANTAGES OF THE NEW INVENTION

1. Organic waste is now safely composted and gives more plant growth at home.
2. Garbage collection, transport, dumping and landfill site costs are nil.
3. Safe organic food of any culture or nation is created at home with no pesticides.
4. National nutrition increases with lower air CO2, global warming levels.
5. City and home air is better with more free oxygen with lower dust & CO2.
6. Soil water retentivity increases & kids learn to use safe earth practices
7. Nations need not waste farm lands, forests for vegetables and fruits.
8. Only open surfaces are used—no land costs except the pot cost and seeds.

We claim:

1. an easy composting garden pot wherein the improvement comprises of a central plant chamber and multiple integrated composting chambers, the said pot (1) of needed shape and size is provided with inside removable partitions (2), the said inside partitions (2) dividing the said pot inside into the two outer compost chambers and a central plant chamber, the said partition having multiple root holes(3) covered by a sliding plate (4), the said plant chamber has an excess water drain hole (6) on one side and is filled with garden soil for the plant.

2. An easy composting garden pot as claimed in claim 1, wherein wheels (10) are fitted to bottom of the pots for shifting the filled pots in use.

3. An easy composting garden pot as claimed in claim 1, wherein the said non transparent pots of chosen shape, size and material has in the plant part a side hole (6) for excess water drain from the said plant chamber and inside on the floor inserts (7) for plant stem supporting tubes.
